(19) United States
(12) Patent Application Publication
(10) Pub. No.: US 2016/0018297 A1
(43) Pub. Date: Jan. 21, 2016

(54) GAS COLLECTION AND MEASUREMENT SYSTEM USING SENSOR TRIGGERING OF SAMPLING EVENTS

(71) Applicants: John Christopher Domaradzki, San Francisco, CA (US); George Adis, Jacksonville, FL (US); Robert J. Chester, Sea Cliff, NY (US)

(72) Inventors: John Christopher Domaradzki, San Francisco, CA (US); George Adis, Jacksonville, FL (US); Robert J. Chester, Sea Cliff, NY (US)

(21) Appl. No.: 14/801,647

(22) Filed: Jul. 16, 2015

Related U.S. Application Data
(60) Provisional application No. 62/025,379, filed on Jul. 16, 2014.

(51) Int. Cl. G01N 1/22

(52) U.S. Cl. CPC G01N 1/2273

(57) ABSTRACT

A system and method for a gas collection and measurement system, the system being automated, the system being triggered by events, the system taking measurements of various meteorological conditions at the time of the sampling events, and the system sending an alert or otherwise transmitting information in real-time so that measured data may be acted upon.

### BACKGROUND

### Description of Related Art

The measurement and sampling of ambient gasses is currently an analog and physical process. It is not currently possible to measure important variables, such as, date, time, location, temperature, humidity, altitude, vacuum, pressure, volatile organic content, wind speed or wind direction, or other electrochemical sensor responses when samples are taken by an ambient gas collection and measurement system. Furthermore, it may not be possible to remotely send results from a measurement and sampling system in real-time. Accordingly, the prior art may not solve the problem of measuring all the desired variables, the triggering of sampling events when desired, or communicate this information in an effective manner because the process of collecting ambient gas samples is dramatically affected by the variables above. Furthermore, if the air samples are not recorded and documented with other meteorological variables, then consistent and accurate sampling and measurements may not be accomplished.

### BRIEF SUMMARY

The present invention is a system and method for a gas collection and measurement system, the system being automated, the system being triggered by events, the system taking measurements of various meteorological conditions, as well as monitoring specific chemical sensor responses, at the time of the sampling events, and the system sending an alert or otherwise transmitting information in real-time so that measured data may be acted upon.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a front elevation view of an eAir™ device.

FIG. 2 is a back elevation view of the eAir device.

FIG. 3 is a block diagram of an eAir system.

FIG. 4 is a photograph of a close-up view of a valve disposed along a seam of a ChemBag™.

FIG. 5 is a photograph of the ChemBag.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention, and should not be viewed as narrowing the claims which follow.

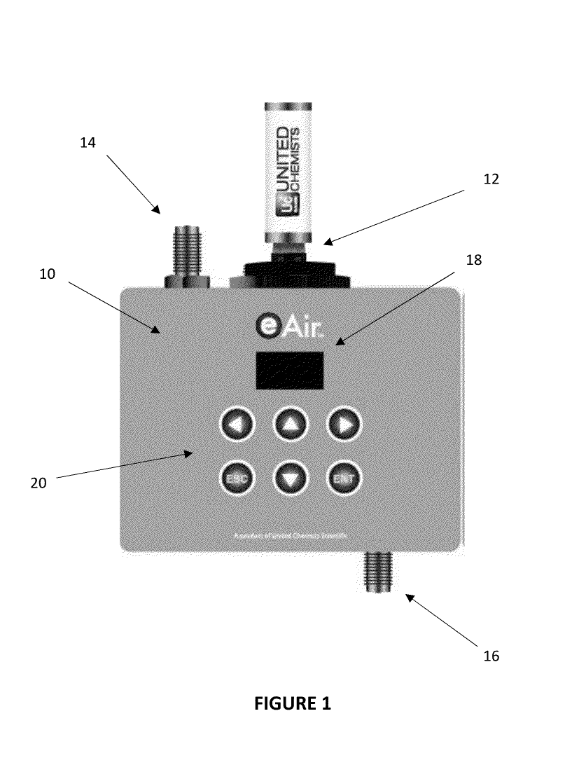

FIG. 1 is a profile view of a first embodiment of the invention. The first embodiment of the invention is directed to a system for taking measurements of various meteorological conditions, and monitoring electrochemical sensors responses at the time of the sampling events. The principles of the first embodiment may be embodied in an eAir device 10 shown in FIG. 1. The eAir device 10 may digitally record date, time, location, temperature, humidity, particulate concentration, volatile organic content via a photoionization detector, vacuum, pressure, wind speed, and wind direction and flow, but should not be considered to be limited to these measurements. This list should be considered exemplary only and not limiting of the types of measurements that may be taken at sampling events.

In this first embodiment, the eAir device 10 may control the flow of gasses through it. Furthermore, the eAir device may provide a digital solution to a currently mechanical problem by electronically controlling flow, while digitally recording ambient values like, date, time, location, volatile organic content, wind speed, wind direction, temperature, humidity, altitude, flow, vacuum and pressure.

It is preferred that the eAir may record and document all of variables above while also controlling the flow of gas sampling and analysis. One advantage of the first embodiment is that this process may allow documenting and measuring of air quality consistently and in a manner that may be legally defensible.

In this embodiment, the circuit board and software may be necessary, however, the sensors such as photoionization detector, mass flow controller, pump, temperature/humidity sensor, wind speed/direction sensor, GPS/Altitude Chip, Communications Chips, vacuum/pressure sensor, chemical sensors, etc. may be stand-alone sensors or they may be combined with others based on need of the user. Advantageously, the eAir device may use other sensors that are not yet developed in order to improve measurement capabilities and analysis.

It is preferred that the collection of the data variables such as date, time, flow, GPS location, altitude, temperature, humidity, wind speed, wind direction, ambient gas chemical sensor data and volatile organic content via a photoionization detector may enable scientists to understand and document ambient air as well as specific gases.

The first embodiment may provide feedback to a user in the form of visualization through graphs and modeling of data sets. The eAir device 10 may advantageously be manufactured to be chemically inert, weather proof, digital, battery operated, and remote controlled which may allow for the device to be used almost anywhere.

Implementing the first embodiment may be possible by providing a circuit board capable of controlling a mass flow controller and pump while collecting results from sensors. The circuit board may be disposed within the eAir device 10, and may include a USB port 12 where a digital drive may be inserted and data placed from use of the eAir device 10. In addition, this circuit board may be designed to accommodate communication chips for remote control and data communication.

The eAir device 10 may also have additional sensors attached to the circuit board. Some examples of other sensors include but should not be limited to a helium detector, carbon and nitrogen oxide sensors, pH meters, XRF sensors, and IR sensors. These sensors may be disposed within the eAir device 10 or may be on the outside and coupled to the circuit board through various connectors on the eAir device 10.

The eAir device 10 may include a mass flow controller (MFC) and/or a variable flow pump (VFP) within it. The eAir device 10 may also include an inlet port 14 to which may be connected, for example, an inline sensor, a sorbent tube or an external gas line. The eAir device 10 may also include an outlet port 16 to which may be connected to, for example, a Summa canister, a Tedlar bag, an external pump or an external gas line. The objects that may be coupled to the inlet port 14 and the outlet port 16 should be only considered as examples only and not an exhaustive list. Other objects may be coupled and fall within the scope of the present invention.

In the first embodiment, the inlet port 14 and the outlet port 16 may be a quarter inch stainless steel fitting as known to those skilled in the art, but other size fittings and adapters may also be substituted for or attached to the eAir device 10.

The eAir device 10 may store data in an internal memory and/or on an external memory device that is coupled to a data port 12. In the first embodiment, the data may be transferred to the external memory device as a csv file. However, it should be understood that the data may be stored and transferred in any convenient form as known to those skilled in the art.

The first embodiment may also include a display 18 and a user interface 20 for communicating with the eAir device 10. The display 18 and user interface 20 may be used for setup, deployment, operation and retrieval of data from the eAir device 10.

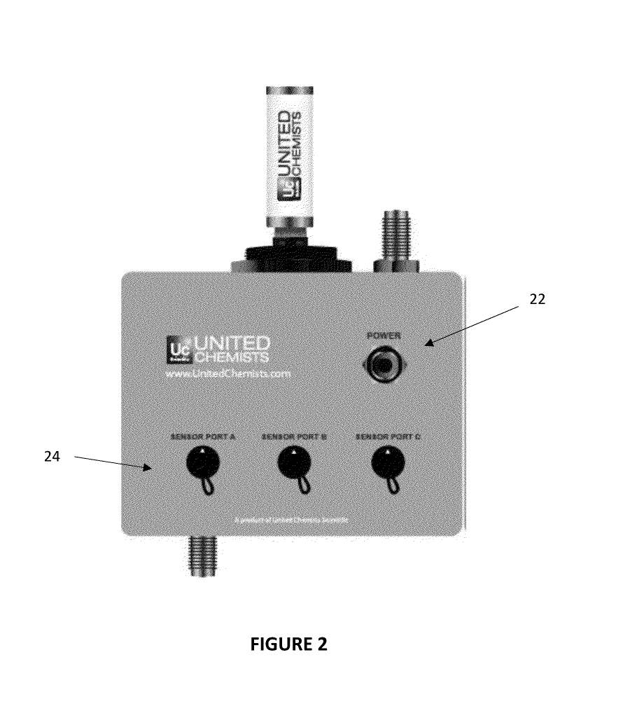

FIG. 2 is a profile view of a back side of the first embodiment of the eAir device 10. The arrangement of ports, user interface and display of the eAir device 10 shown in FIGS. 1 and 2 should be understood to be an example only and not limiting of the scope of the invention. The features of the eAir device 10 may be changed and not alter the scope of the invention.

The back side of the eAir device 10 shown in FIG. 2 shows a power port 22 and a plurality of external sensor inputs 24. The number and position of the power port 22 and the plurality of external sensor inputs 24 should not be considered as limiting and is only an illustration of one configuration that may be used.

In this first embodiment, the plurality of external sensor inputs 24 may allow for the connection of inline and auxiliary sensors and pumps. In the first embodiment, the eAir device 10 may include several different sensors, such as but not limited to, flow, vacuum, pressure and GPS.

The power port 22 may be coupled to an AC power source, a rechargeable battery or a solar power system, but should not be considered to be limited to these options.

The housing of the eAir device 10 in the first embodiment may be an IP-66 rated enclosure so as to be weatherproof and durable. The housing should not be considered to be limited to this standard and it may be modified as needed without departing from the scope of the invention. In the first embodiment, the housing and internal components of the eAir device 10 may be considered to be a handheld portable device that may weigh anywhere from 0.2 to 20 pounds. The eAir device 10 may be used as a temporary installation or as a permanently installed device.

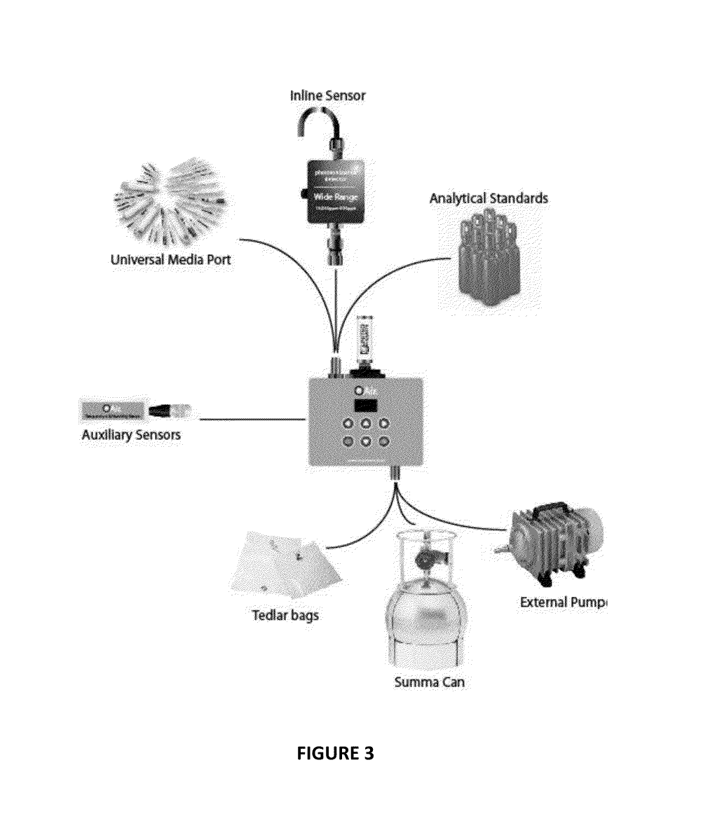

FIG. 3 is an illustration of an example of the various objects that may be coupled to the input and output ports 14, 16 of the eAir device 10 as discussed above in relation to FIGS. 1 and 2.

Operation of the first embodiment of the eAir device 120 may be to understand air contamination and/or ambient conditions. The first embodiment may be used to understand both indoor and outdoor air quality by documenting flow, vacuum, and pressure, volatile organic content via a photoionization detector, temperature, humidity, wind speed, wind direction, GPS location and altitude. Once these data variables are collected, a user may have a better understanding of the conditions affecting air quality. The subsequent analysis of air through EPA, OSHA, NISOH, ASTM or other regulatory methods in concert with the results supplied by the eAir device may give a complete view of air and its quality.

The first embodiment may also operate under the control of software. The first embodiment is presently operated using a software program called AirView™, but should not be considered as limited by this control software. Any software that can operate the eAir device 10 may be considered to be within the scope of the invention. This software enables a user to view and understand air results provided by the eAir device, subsequent air analysis, and National Oceanic and Atmospheric Administration data. This software may provide users with the ability to model and visualize data sets collected by the eAir device.

The first embodiment of the system may include an eAir device 10 which may be a replacement for a mass flow controller used in EPA Method TO-15 or other associated air analysis methods. The first embodiment may be digital, weather proof, may have an inert sample path and may be battery operated. The eAir device may be programmable and may control gas flow from 0.1 ml/min to 10,000 ml/min while digitally documenting date, time, and total organic content via a Photoionization detector, temperature, humidity, wind speed, wind direction, GPS location, altitude, and gas flow. All of these real-time data points may be saved on a standard USB drive.

The data generated by the eAir device 10 may record previously unavailable data variables. Simple measurements like wind speed, temperature, humidity, GPS location, and flow may affect concentration. If all of this data is compiled onto a USB drive, it may be possible to generate graphs and illuminating relationships between data variables. Data may be mathematically derived and displayed using Excel® or other spreadsheet programs.

By making the first embodiment of the eAir device 10 programmable and flexible, the system may automate sampling events while documenting the entire event for subsequent analysis. When combined with several simultaneous sampling events, it may now be possible to provide an improved model of air and how it interacts with its local environment, including the ability model air around a point source, which is believed to have never been measured or seen before in conjunction with the ambient air data describe herein.

Another aspect of the first embodiment is how the data that is collected is used. The prior art fails to provide a means for using the data in real-time. For example, if the data that is being collected were known to specific users, that data may indicate that some action should be taken or a specific response should take place. The problem is that air monitoring systems such as the first embodiment are not monitored in real-time. Accordingly, another aspect of the first embodiment is that the system may be capable of performing some analysis. For example, if certain measured conditions fall outside set parameters; this information could be useful if it was known. The first embodiment therefore also includes the ability to communicate information in real-time.

For example, the data and/or an analysis of the data may be transmitted to a specific location or broadcast to a wider audience. Communication may take place over the Internet, a dedicated communication cable, wirelessly over a cellular network or by some other communication network. The data may be sent to a location so that others may publish the information or send an alert. Alternatively, the data may be broadcast automatically over a communication system such as Twitter®. What is important is that the first embodiment may be capable of sending data in real-time and the data may include a message or just data without analysis.

In another aspect of the first embodiment, the eAir system may include or have real-time access to regulatory or other databases. These databases may enable the eAir system to make comparisons of the data collected to data in the databases in order to provide real-time analysis of data, and thus provide warnings when the collected data is outside parameters provided by the databases.

Consider the example of the first embodiment implemented in a stadium or other location where people are gathered and where air quality may be monitored. If one or more of the eAir system collects data that is outside a set parameter, then a single eAir system or a network of eAir systems may transmit a warning that the area being monitored should be evacuated. This example is only a single illustration of how the system can use data in real-time and should not be considered to be limiting of the applications of the first embodiment.

Air samples may be collected using various devices and containers in conjunction with the eAir system. These containers may be spherical containers such as a Summa™ canister including but not limited to the UC/WLS design as viable sampling vessels to be used in conjunction with the eAir monitoring/sampling device, or they may be containers having other desirable shapes and/or characteristics.

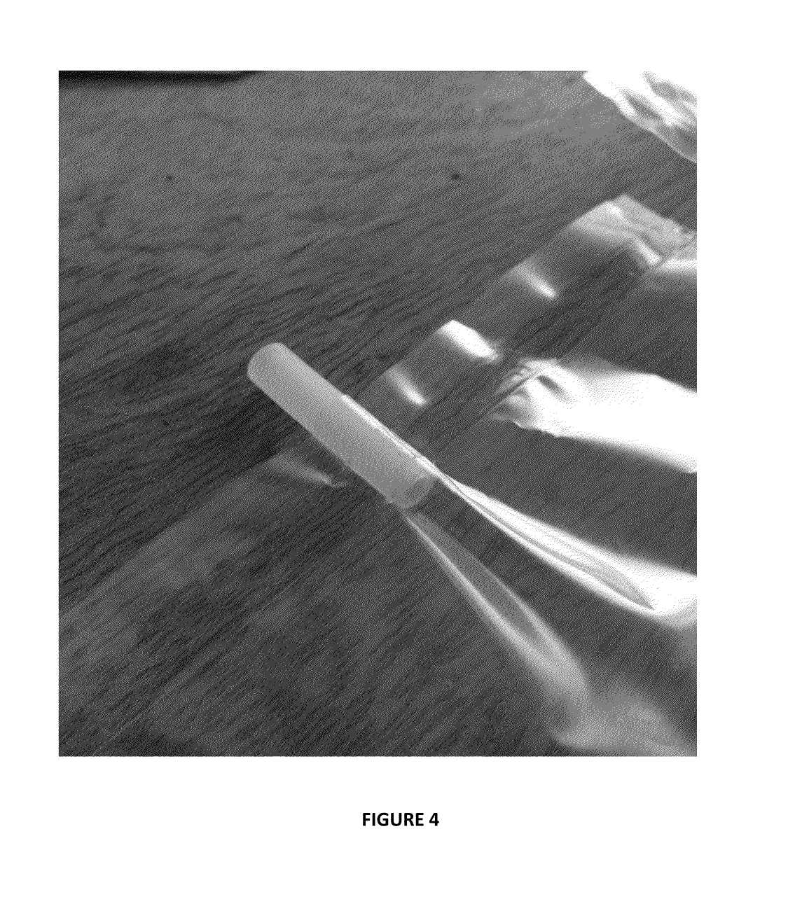

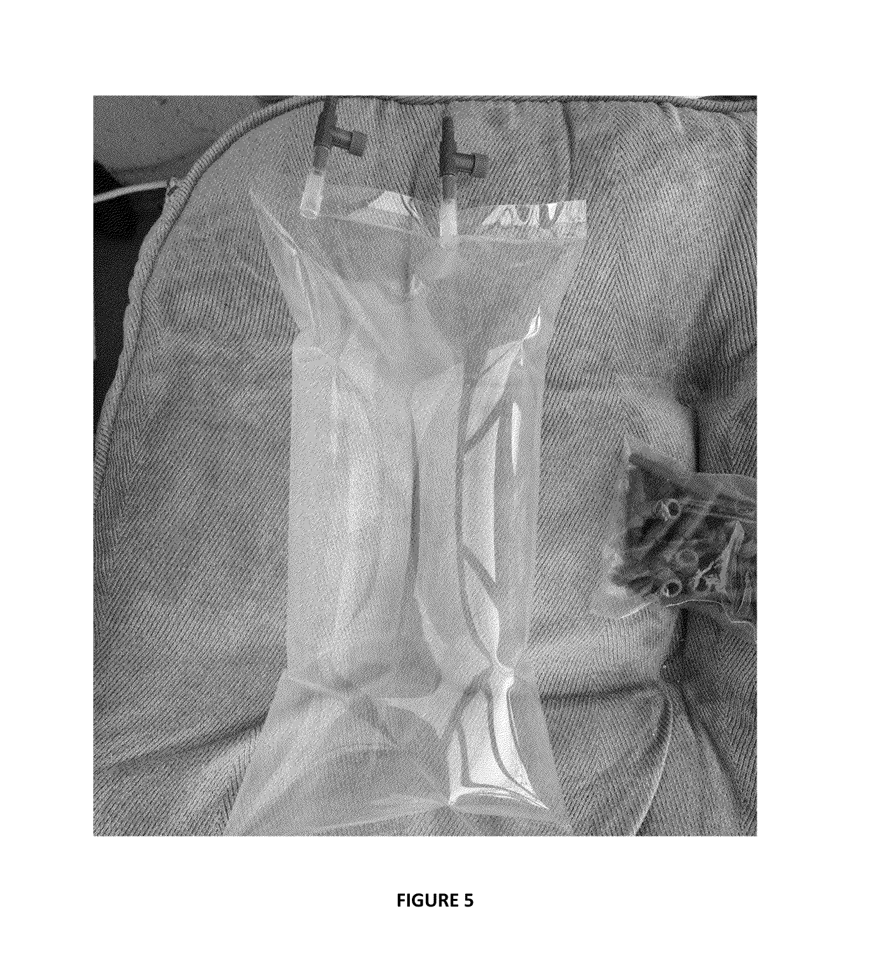

Another embodiment of the present invention is directed to a product known as the ChemBag™ and is illustrated in FIGS. 4 and 5. The ChemBag may provide an improved collection container for air samples. Instead of using difficult-to-install valves in the middle of a bag, the third embodiment is directed to a bag having valves installed on an edge thereof. The ChemBag may be manufactured using materials including, but not limited to, Tedlar, FEP, and Multi-foil. Using, RFID technology on the bags, the samples are easier to document and track. The ChemBag may be manufactured at less cost than the prior art containers, may be less susceptible to damage because of the location of the valves, and use less expensive components.

Another embodiment is the creation of an eWater™ system. The eWater system may operate on the same principles of the eAir device 10, including the ability to transmit data in real-time. The eWater system is directed to the monitoring of fluids just as the eAir system is directed to the monitoring of gases. The sensors that are used with the eWater system are directed toward measuring data that is relevant to water content and/or quality. The AirView program may be used with both eAir and eWater and provide the same functionality.

In another aspect, a smartphone may have sensors that can be measured by a smartphone application. For example, iSense™ may be comprised of smartphone compatible sensors such as, but limited to, PID, Particulates, electrochemical sensors, etc. These sensors may be coupled to a smartphone via an audio or other port. The iSense app may be loaded and run on the smartphone and provide the ability to record measurements as well as provide a graphical user interface.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for automated measurement and sampling of ambient gases, said method comprising the steps of:
performing a sampling event defined as a measurement of at least one desired attribute regarding ambient gases and recording results of the sampling event; and
simultaneously recording at least one meteorological variable associated with each sampling event.

2. The method as defined in claim 1 wherein the method further comprises the step of controlling timing of the sampling event.

3. The method as defined in claim 2 wherein the method further comprises the step of controlling timing of the sampling event by selecting a trigger from the group of triggers comprised of a remote control user trigger, a pre-programmed meteorological condition, and a table of times.
